(19) United States
(12) Patent Application Publication
(10) Pub. No.: US 2026/0330169 A1
(43) Pub. Date: Oct. 22, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: YUTAKA INOUE, Tokyo (JP)

(21) Appl. No.: 19/637,674

(22) Filed: Apr. 2, 2026

(30) Foreign Application Priority Data
Apr. 17, 2025 (JP) 2025-068165

(51) Int. Cl. G06K 15/02; G06K 15/00

(52) U.S. Cl. CPC G06K 15/186; G06K 15/007; G06K 15/022; G06K 15/408

(57) ABSTRACT

A processing apparatus communicating with a printing apparatus includes an acquisition unit configured to acquire a skew amount in feeding of a print medium, detected by the printing apparatus, a creation unit configured to create a print image based on the acquired skew amount, to cause a protruding amount of borderless printing in a case where the skew amount is small to be smaller than the protruding amount of the borderless printing in a case where the skew amount is large, and an output unit configured to output the created print image to the printing apparatus.

### BACKGROUND

### Field of the Technology

The aspect of the embodiments relates to an information processing apparatus, a method of controlling the information processing apparatus, and a storage medium.

### Description of the Related Art

In a case where borderless printing using roll sheet is performed, a printer receives an image having a size larger than a sheet outer size, and cuts a portion protruding from the sheet outer size, thereby realizing borderless printing. An image area protruding from the sheet outer size is referred to as a protruding amount. The roll paper may be conveyed while being skewed in printing, but printing is performable by allowing slight skew except for a case where the paper is largely skewed.

Japanese Patent Laid-Open No. 2005-74853 describes a technique in which a sensor provided on a printer detects ends of a sheet with respect to slight skew, and printing is performed while a print starting position is shifted based on skew of the sheet.

The technique described in Japanese Patent Laid-Open No. 2005-74853 can avoid an issue that paper white of the sheet not printed due to skew appears; however, even in a case where the skew is little, the printer performs printing by constantly receiving a fixed protruding amount greater than the sheet outer size, which increases image loss.

### SUMMARY

According to an aspect of the embodiments, a processing apparatus communicating with a printing apparatus includes an acquisition unit configured to acquire a skew amount in feeding of a print medium, detected by the printing apparatus, a creation unit configured to create a print image based on the acquired skew amount, to cause a protruding amount of borderless printing in a case where the skew amount is small to be smaller than the protruding amount of the borderless printing in a case where the skew amount is large, and an output unit configured to output the created print image to the printing apparatus.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a hardware configuration of an information processing system.

FIG. 2 is a diagram illustrating a configuration example of an information processing apparatus illustrated in FIG. 1.

FIG. 3 is a diagram illustrating a configuration example of a sheet-width-end detection sensor illustrated in FIG. 1.

FIG. 4 is a diagram illustrating an operation screen relating to a borderless protruding amount on a user interface unit of print processing software.

FIG. 5 is a flowchart for an image forming apparatus to detect sheet ends.

FIG. 6 is a flowchart for the print processing software in the information processing apparatus to acquire a skew amount from the image forming apparatus.

FIG. 7 is a flowchart for the print processing software in the information processing apparatus to determine a protruding amount based on the skew amount and to perform print processing.

FIG. 8 is a flowchart for determining the protruding amount based on the skew amount.

FIGS. 9A and 9B are diagrams each illustrating an output image of borderless printing.

FIG. 10 is a flowchart for displaying a warning message in a case where the skew amount exceeds a threshold.

FIG. 11 is a diagram illustrating an example of the warning message.

### DESCRIPTION OF THE EMBODIMENTS

An embodiment of the present technique is described in detail below with reference to drawings. The following embodiment does not limit the present technique according to the claims, and all of the combinations of features described in the embodiment are not necessarily essential for a solution of the present technique.

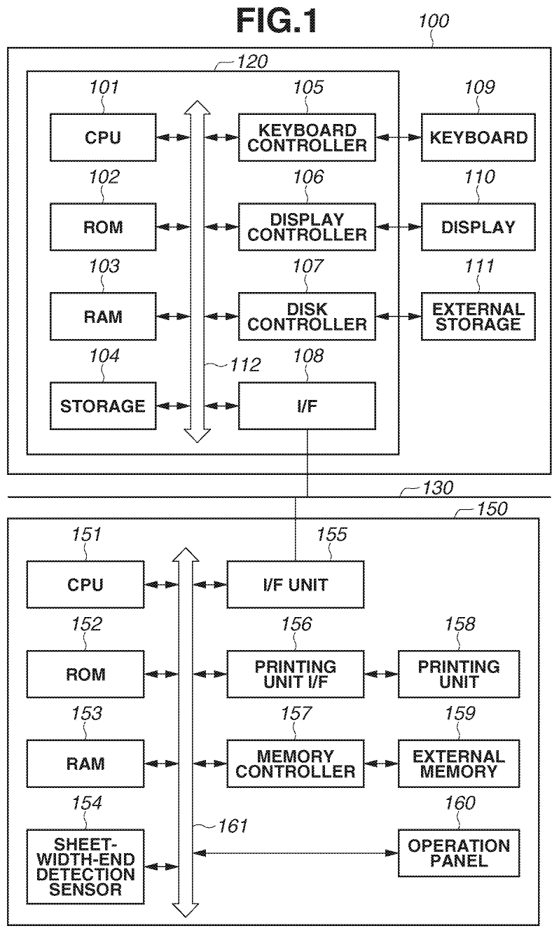

FIG. 1 is a diagram illustrating an example of a hardware configuration of an information processing system according to the embodiment. The information processing system includes an information processing apparatus 100, a network 130, and an image forming apparatus 150.

The information processing apparatus 100 can be connected to the image forming apparatus 150 through the network 130. The information processing apparatus 100 creates a print job, and transmits print data to the image forming apparatus 150. The information processing apparatus 100 is an example of a diagram illustrating a configuration of a computer.

The information processing apparatus 100 includes a computer internal device 120, a keyboard 109, a display 110, and an external storage 111.

The computer internal device 120 includes a central processing unit (CPU) 101, a read only memory (ROM) 102, a random access memory (RAM) 103, a storage 104, a keyboard controller 105, a display controller 106, a disk controller 107, an interface (I/F) 108, and a main bus 112.

The CPU 101 reads out various kinds of programs such as control programs, system programs, and application programs from the external storage 111 to the RAM 103 through the disk controller 107. The CPU 101 executes the various kinds of programs read out to the RAM 103 to perform various kinds of data processing and display control of the display 110. The CPU 101 may read out the control programs and the like from the ROM 102. The CPU 101 may be a dedicated circuit such as an application specific integrated circuit (ASIC).

The disk controller 107 controls access to the external storage 111 such as a hard disk (HD), a compact disk-read only memory (CD-ROM), a digital versatile disk-read only memory (DVD-ROM), or a universal serial bus (USB).

The RAM 103 is configured such that a capacity of the RAM 103 can be extended by an optional RAM or the like (not illustrated), and is mainly used as a work area for the CPU 101.

The keyboard controller 105 controls key input from the keyboard 109 and a pointing device (not illustrated).

The display controller 106 controls display of the display 110. The CPU 101 can perform communication processing with the image forming apparatus 150 through the I/F 108.

In the embodiment, unless otherwise noted, the CPU 101 controls each of the units connected to the main bus 112 through the main bus 112.

The image forming apparatus 150 includes a CPU 151, a ROM 152, a RAM 153, a sheet-width-end detection sensor 154, an I/F unit 155, a printing unit I/F 156, a memory controller 157, a printing unit 158, an external memory 159, an operation panel 160, and a system bus 161.

The image forming apparatus 150 is controlled by the CPU 151. The CPU 151 operates based on control programs and the like stored in a program ROM of the ROM 152. The CPU 151 outputs image data as output information to the printing unit (printer engine) 158 connected to the printing unit I/F 156 through the system bus 161. The CPU 151 can perform communication processing with the information processing apparatus 100 through the I/F unit 155, and can notify the information processing apparatus 100 of information inside the image forming apparatus 150. Further, the CPU 151 can receive output data to be output to the printing unit 158 through the I/F unit 155.

The RAM 153 functions as a main memory, a work area, and the like for the CPU 151. The RAM 153 is used as an output information loading area, an environment data storage area, a nonvolatile memory, and the like.

The sheet-width-end detection sensor 154 detects ends of a sheet in a width direction, and detects a width size and positions of the sheet ends. The sheet-width-end detection sensor 154 may be a single sensor unit provided on a main body of the image forming apparatus 150, or may be, in a case of an inkjet printer, a device attached to a printing head ejecting ink. The detected information is temporarily held by the RAM 153.

Access to the external memory 159 such as an HDD or an integrated circuit (IC) card is controlled by the memory controller 157. The external memory 159 can be optionally connected, and can store font data, emulation programs, form data, information about a sheet registered to the image forming apparatus, and the like.

The operation panel 160 can display various kinds of information, and enable operation of various kinds of information.

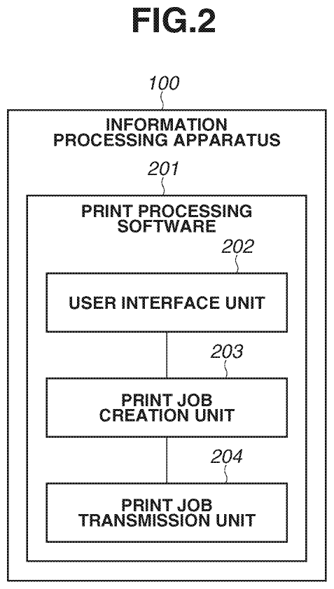

FIG. 2 is a diagram illustrating a configuration inside the information processing apparatus 100 illustrated in FIG. 1. The information processing apparatus 100 includes print processing software 201 represented by a printer driver or the like. The print processing software 201 includes a user interface unit 202, a print job creation unit 203, and a print job transmission unit 204.

The user interface unit 202 can be operated by a user. The print job creation unit 203 receives data created by application software or the like, converts the data into data that can be interpreted by the image forming apparatus 150, and adds a print command to the converted data. The print job transmission unit 204 transmits print data created by the print job creation unit 203 as a print job to the image forming apparatus 150.

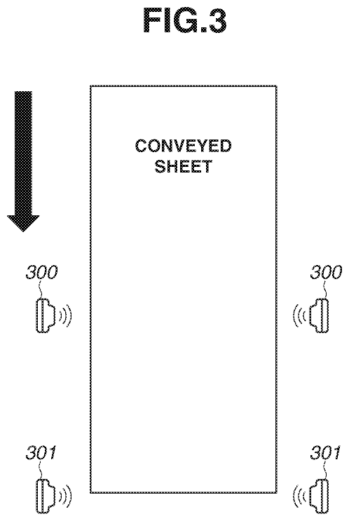

FIG. 3 is a diagram illustrating a configuration example of the sheet-width-end detection sensor 154 described with reference to FIG. 1. The sheet-width-end detection sensor 154 includes sensors 300 and 301.

When the image forming apparatus 150 conveys a sheet, the sensors 301 can read a size and a position of the sheet at a leading edge of the sheet. Further, the sensors 300 can similarly read the size and the position of the sheet at a position separated by a predetermined distance from the leading edge of the sheet. The sheet-width-end detection sensor 154 can measure a skew amount of the sheet from differences between the size and the position of the leading edge and the size and the position of the portion separated by the predetermined distance from the leading edge. Note that the sensors 301 and 300 indicate concepts of detection positions by the sensor rather than presence of four physical sensors.

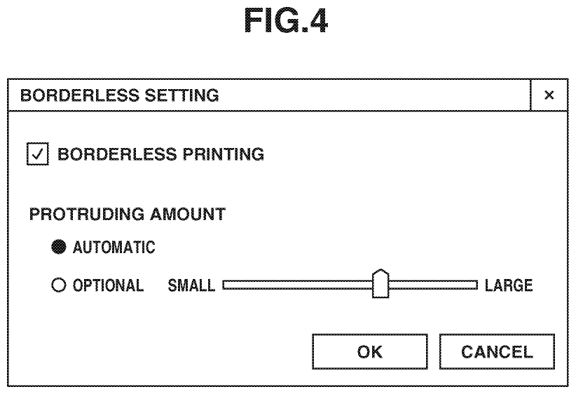

FIG. 4 is a diagram illustrating an operation screen relating to a borderless protruding amount on the user interface unit 202 of the print processing software 201. It is possible to select whether to designate borderless printing, by a checkbox. When a checkbox of the borderless printing is checked, setting of the protruding amount becomes selectable. Selectable settings of the protruding amount include an automatic setting and an optional setting. In a case of the optional setting, the size can be selected from a plurality of sizes from a small size to a large size in order to create an image having a size greater than the sheet outer size. In a case of the automatic setting, the protruding amount is calculated based on information on the skew amount of the sheet acquired from the image forming apparatus 150, and an image is created.

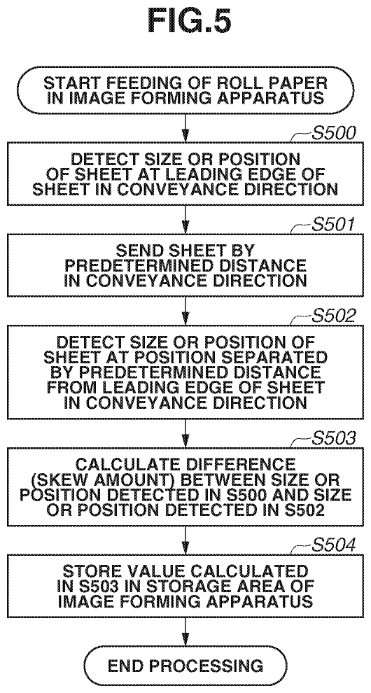

FIG. 5 is a flowchart for the image forming apparatus 150 to detect sheet ends by the configuration of the sheet-width-end detection sensor 154 illustrated in FIG. 3. The flowchart illustrated in FIG. 5 is realized when the programs recorded in the ROM 152 are loaded to the RAM 153, and the CPU 151 executes the programs. The CPU 151 controls to start feeding of a sheet. The sheet is, for example, roll paper, and is an example of a print medium. The image forming apparatus 150 is an example of a printing apparatus.

In step S500, the CPU 151 detects a size or a position of the sheet at a leading edge of the sheet in a conveyance direction by the sensors 301 of the sheet-width-end detection sensor 154.

In step S501, the CPU 151 feeds the sheet by a predetermined distance in the conveyance direction.

In step S502, the CPU 151 detects the size or the position of the sheet at a position separated by the predetermined distance from the leading edge of the sheet by the sensors 300 of the sheet-width-end detection sensor 154.

In step S503, the CPU 151 calculates, as a skew amount of the sheet, a difference between the size or the position detected in step S500 and the size or the position detected in step S502.

In step S504, the CPU 151 stores the calculated skew amount of the sheet in the RAM 153 of the image forming apparatus 150.

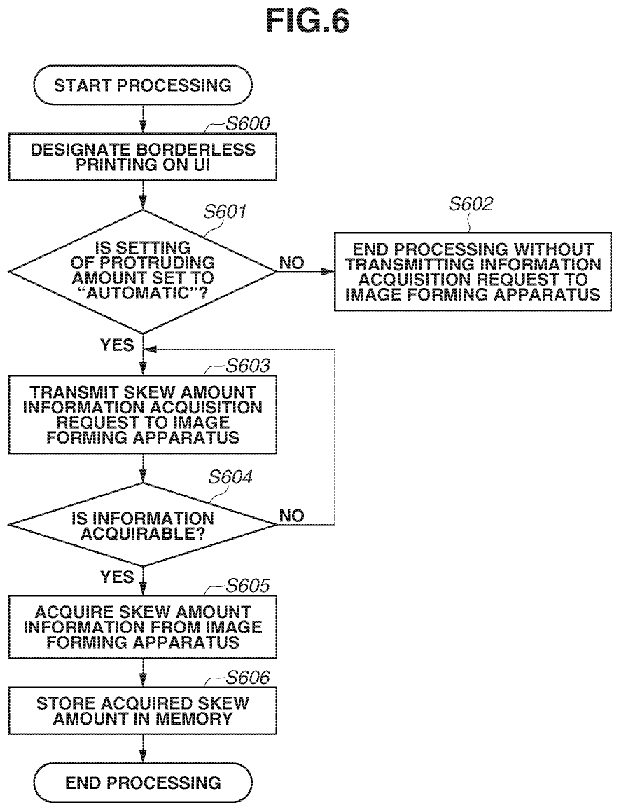

FIG. 6 is a flowchart for the print processing software 201 in the information processing apparatus 100 to acquire the skew amount of the sheet obtained in FIG. 5, from the image forming apparatus 150. The flowchart illustrated in FIG. 6 is realized when the programs recorded in the external storage 111 are loaded to the RAM 103, and the CPU 101 executes the programs. The information processing apparatus 100 can communicate with the image forming apparatus 150. In the following, a method of controlling the information processing apparatus 100 is described.

In step S600, the CPU 101 performs control to display the screen for selecting the automatic setting or an optional designated value of the protruding amount of the borderless printing illustrated in FIG. 4. The borderless printing is designated in response to operation on the UI on the operation screen illustrated in FIG. 4.

In step S601, the CPU 101 determines which of the automatic setting and the optional designated value has been selected as setting of the protruding amount of the borderless printing in the operation screen illustrated in FIG. 4. In a case where the optional designated value has been selected (NO in step S601), the processing proceeds to step S602. In a case where the automatic setting has been selected (YES in step S601), the processing proceeds to step S603.

In step S602, the processing in the flowchart illustrated in FIG. 6 ends without transmitting a skew amount information acquisition request to the image forming apparatus 150 because the CPU 101 uses the optional designated value selected in FIG. 4.

In step S603, the CPU 101 transmits the skew amount information acquisition request to the image forming apparatus 150.

In step S604, the CPU 101 determines whether a response from the image forming apparatus 150 has been received. In a case of no response, the information is not acquirable (NO in step S604). Thus, the processing returns to step S603, and retry is repeated. In a case where a response has been received, the information is acquirable (YES in step S604), and the processing proceeds to step S605.

In step S605, the CPU 101 acquires the skew amount information in feeding of the sheet, detected by the image forming apparatus 150, from the image forming apparatus 150.

In step S606, the CPU 101 stores the acquired skew amount in feeding of the sheet in the RAM 103.

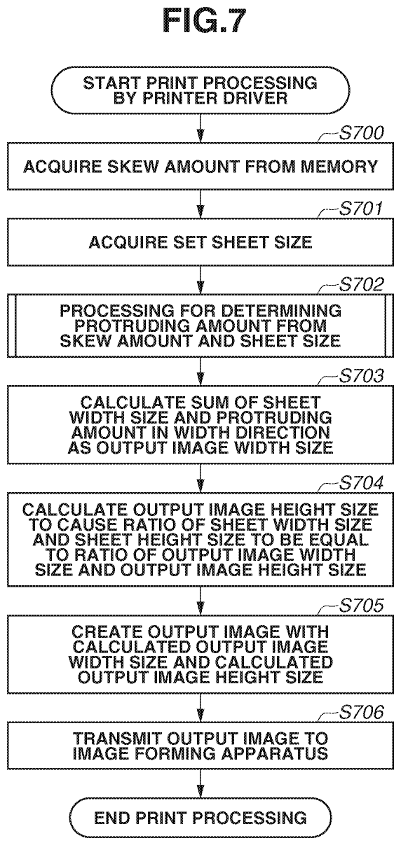

FIG. 7 is a flowchart for the print processing software 201 in the information processing apparatus 100 to determine a protruding amount based on the skew amount and to perform print processing. The flowchart illustrated in FIG. 7 is realized when the programs recorded in the external storage 111 are loaded to the RAM 103, and the CPU 101 executes the programs. The CPU 101 starts the processing in the flowchart illustrated in FIG. 7 in response to a print execution instruction from the printer driver of the print processing software 201.

In step S700, the CPU 101 acquires the skew amount in feeding of the sheet held in step S606 from the RAM 103.

In step S701, the CPU 101 acquires a sheet size set in the printer driver.

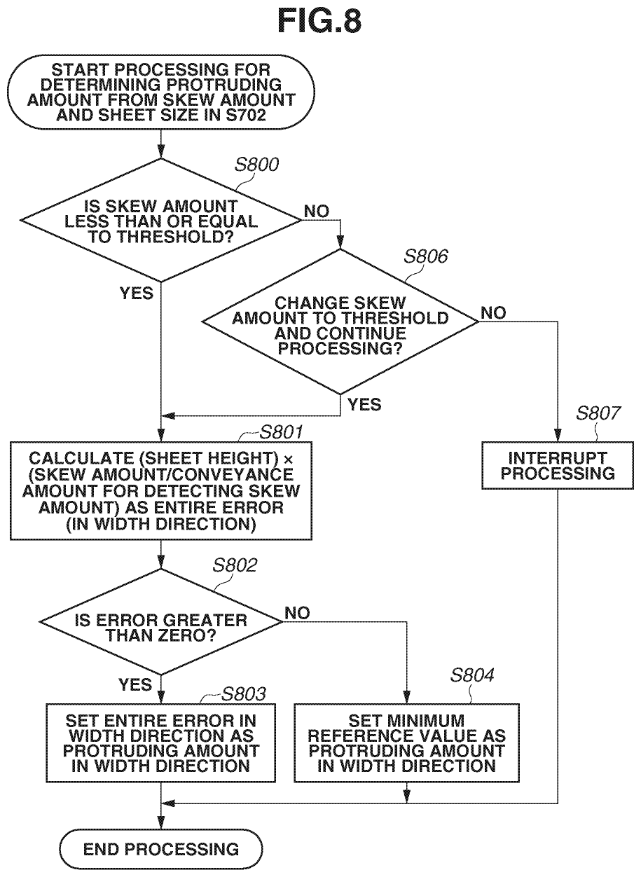

In step S702, the CPU 101 performs processing for determining the protruding amount of the sheet in the width direction from the skew amount of the sheet and the sheet size. The processing is described below with reference to FIG. 8.

In step S703, the CPU 101 calculates a sum of the protruding amount in the width direction and the sheet width size as an output image width size.

In step S704, the CPU 101 calculates an output image height size such that a ratio of the sheet width size and the sheet height size is equal to a ratio of the output image width size and the output image height size.

In step S705, the CPU 101 creates an output image with the output image width size and the output image height size. The output image is an example of a print image. Since the protruding amount is determined in step S702, the CPU 101 can create the output image such that the protruding amount of the borderless printing in a case where the skew amount is small is smaller than the protruding amount of the borderless printing in a case where the skew amount is large.

In the borderless printing, an output image having a size larger than the sheet size is created, and printing is performed such that the output image protrudes from the sheet. The protruding amount of the borderless printing is an amount of a portion of the output image protruding from the sheet size.

In step S706, the CPU 101 outputs (transmits) the output image (print job) created in step S705 to the image forming apparatus 150.

FIG. 8 is a flowchart illustrating details of the processing in step S702. The processing for the print processing software 201 in the information processing apparatus 100 to determine the protruding amount based on the skew amount is described. The flowchart illustrated in FIG. 8 is realized when the programs recorded in the external storage 111 are loaded to the RAM 103, and the CPU 101 executes the programs.

In step S800, the CPU 101 determines whether the skew amount of the sheet is less than or equal to a predetermined threshold. As an example, description is given assuming that the skew amount that is an error amount of a sheet width starting position in the width direction between the leading edge and the position separated by 200 mm calculated in step S503 is 0.8 mm, and the sheet size used for printing is International Organization for Standardization (ISO) A 0 size (841 mm×1189 mm). In a case where the skew amount is less than or equal to the threshold in step S800 (YES in step S800), the processing proceeds to step S801. In a case where the skew amount is greater than the threshold in step S800 (NO in step S800), the processing proceeds to step S806.

In step S806, the CPU 101 determines whether to change the skew amount of the sheet to the threshold and to continue the processing based on user operation and the like. In a case where the processing is continued (YES in step S806), the CPU 101 changes the skew amount of the sheet to the threshold, and the processing proceeds to step S801. In a case where the processing is not continued (NO in step S806), the processing proceeds to step S807.

In step S807, the CPU 101 interrupts the processing, and the image forming apparatus 150 feeds the sheet again.

In step S801, the CPU 101 calculates an entire error in the width direction based on the sheet height size, the skew amount, and a conveyance amount by which the image forming apparatus 150 conveys the sheet to detect the skew amount. More specifically, the CPU 101 calculates sheet height size (1189 mm)×skew amount (0.8 mm)/conveyance amount for detecting skew amount (200 mm), as the entire error in the width direction. The value (4.756 mm) obtained in step S801 is the entire error in the width direction.

In step S802, the CPU 101 determines whether the entire error in the width direction is greater than zero. In a case where the entire error in the width direction is greater than zero (YES in step S802), the processing proceeds to step S803. In a case where the entire error in the width direction is zero (in case where skew amount is zero) (NO in step S802), the processing proceeds to step S804.

In step S803, the CPU 101 sets the entire error in the width direction as the protruding amount (4.756 mm) in the width direction. Thereafter, the processing ends.

In step S804, the CPU 101 sets a minimum reference value as the protruding amount in the width direction. Thereafter, the processing ends.

For example, in a case where the skew amount is 0.8 mm that is not relatively large, the protruding amount in the width direction can be reduced. In a case where the skew amount is small, the protruding amount in the width direction can be further reduced in proportion. Depending on the case, the protruding amount in the width direction can be brought close to 0 mm as much as possible; however, in this case, there is a risk that a printed area cannot cover the entire sheet, and paper white appears. Therefore, the minimum reference value may be set as a minimum line in order to avoid the risk, thereby preventing the protruding amount from being lower than the minimum reference value.

The threshold may be a predetermined fixed value or a variable value. In a case of a fixed value, the threshold is a determined value such as 3 mm or 5 mm. In a case of a variable value, as an example, it is possible to determine the threshold such that a ratio of the difference of the width size between the leading edge and a trailing edge of the sheet, to the sheet width size is a predetermined ratio.

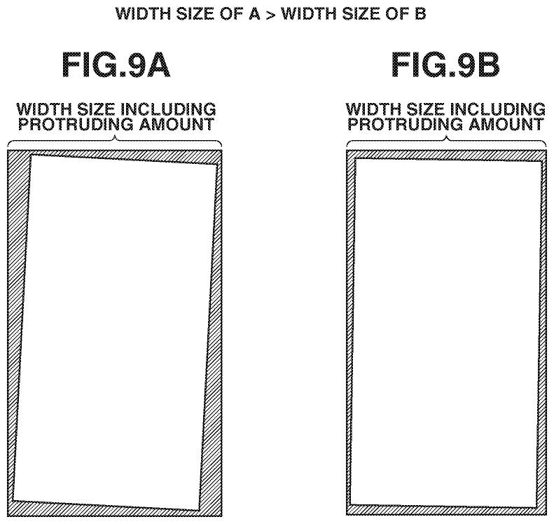

FIGS. 9A and 9B are diagrams each illustrating an output borderless printed image. In FIGS. 9A and 9B, a white area is a printed area where printing is performed in a skewed state, and a frame surrounding an outer hatched area indicates a size of print data including a protruding amount including the printed area of the skewed portion. FIG. 9A illustrates a case where the skew amount is large, and FIG. 9B illustrates a case where the skew amount is not so large. The width size of the print data illustrated in FIG. 9A is larger than the width size of the print data illustrated in FIG. 9B. The protruding amount is small in the case where the skew amount is small.

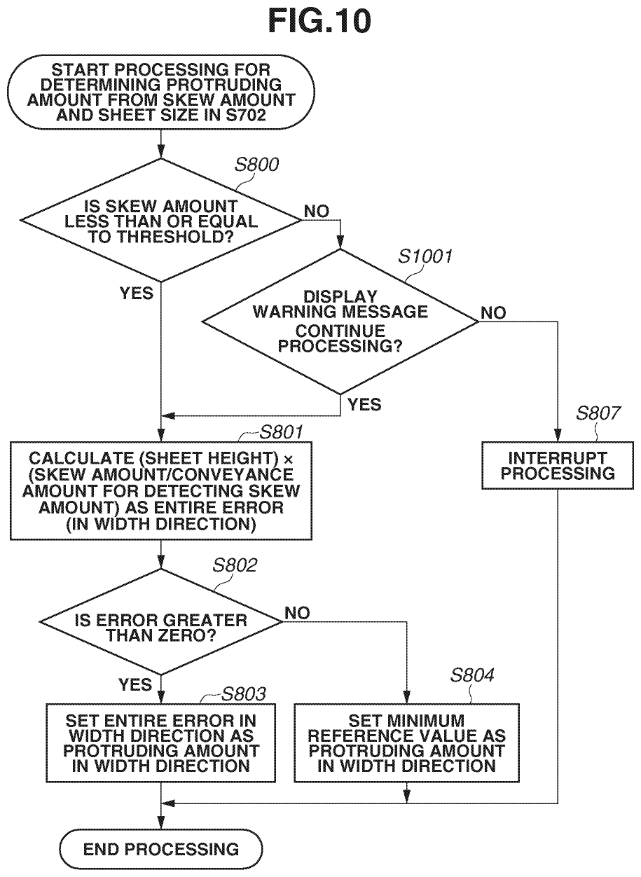

FIG. 10 is a flowchart for displaying a warning message in a case where the skew amount of the sheet exceeds the threshold. The flowchart illustrated in FIG. 10 is realized when the programs recorded in the external storage 111 are loaded to the RAM 103, and the CPU 101 executes the programs.

The flowchart illustrated in FIG. 10 includes a step S1001 in place of step S806 in the flowchart illustrated in FIG. 8. The steps in FIG. 10 and the steps in FIG. 8 are the same except for step S1001.

In step S800, in a case where the skew amount of the sheet is greater than the threshold (NO in step S800), the processing proceeds to step S1001.

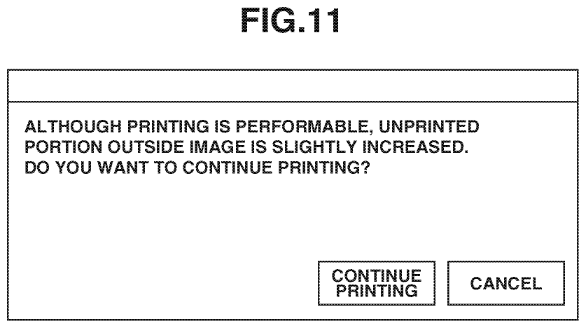

In step S1001, the CPU 101 performs control to display a warning message to call attention. FIG. 11 described below illustrates an example of the warning message. The CPU 101 determines whether a “CONTINUE PRINTING” button has been pressed in the warning message illustrated in FIG. 11. In a case where the “CONTINUE PRINTING” button has been pressed (YES in step S1001), the processing proceeds to step S801. In a case where a “CANCEL” button has been pressed (NO in step S1001), the processing proceeds to step S807.

FIG. 11 is a diagram illustrating the example of the warning message displayed in step S1001. In a case where the “CONTINUE PRINTING” button is pressed, the printing is continued, whereas in a case where the “CANCEL” button is pressed, the print processing is canceled. After the printing is canceled, the image forming apparatus 150 feeds the sheet again.

As described above, according to the embodiment, the information processing apparatus 100 can perform printing by setting an appropriate protruding amount based on the skew amount of the sheet while reducing the protruding amount as much as possible. In a case where the skew amount is little, the information processing apparatus 100 can reduce the protruding amount, reduce image missing and ink consumption, and set the appropriate protruding amount based on the skew amount.

The above-described various kinds of control described as control performed by the CPU may be performed by one piece of hardware, or a plurality of pieces of hardware (e.g., a plurality of processors and circuits) may share the processing to control the entire apparatus.

Although the present technique is described in detail based on the embodiment, the present technique is not limited to these specific embodiments, and also includes various forms within a range not departing from the gist of the technique. Furthermore, the above-described embodiments are merely embodiments of the present technique, and can be appropriately combined.

In the above-described embodiments, the case where the present technique is applied to the information processing apparatus 100 is described as an example; however, the present technique is not limited to the example, and is applicable to an information processing apparatus that can communicate with the image forming apparatus 150. In other words, the present technique is applicable to the information processing apparatus 100, a personal computer, a personal digital assistant (PDA), a mobile phone terminal, and the like.

According to the present technique, it is possible to set the appropriate protruding amount based on the skew amount.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-068165, filed Apr. 17, 2025, which is hereby incorporated by reference herein in its entirety.

What is claimed is:

1. A processing apparatus communicating with a printing apparatus, the processing apparatus comprising at least one processor; and at least one memory coupled to the at least one processor storing instructions that, when executed by the at least one processor, cause the at least one processor to function as:
an acquisition unit configured to acquire a skew amount in feeding of a print medium, detected by the printing apparatus;
a creation unit configured to create a print image based on the acquired skew amount, to cause a protruding amount of borderless printing in a case where the skew amount is small to be smaller than the protruding amount of the borderless printing in a case where the skew amount is large; and
an output unit configured to output the created print image to the printing apparatus.

2. The processing apparatus according to claim 1, wherein the at least one processor further functions as a first control unit configured to perform control to display a warning message in a case where the acquired skew amount is greater than a threshold.

3. The processing apparatus according to claim 1,
wherein the at least one processor further functions as a second control unit configured to perform control to display a screen for selecting automatic setting or designation of the protruding amount of the borderless printing, and
wherein, in a case where the automatic setting of the protruding amount of the borderless printing is selected, the creation unit creates the print image to cause the protruding amount of the borderless printing in the case where the skew amount is small to be smaller than the protruding amount of the borderless printing in the case where the skew amount is large.

4. The processing apparatus according to claim 1, wherein the print medium is roll paper.

5. The processing apparatus according to claim 1,
wherein, in the borderless printing, the print image having a size larger than a size of the print medium is created, and printing is performed to cause the print image to protrude from the print medium, and
wherein the protruding amount of the borderless printing is an amount of a portion of the print image protruding from the size of the print medium.

6. The processing apparatus according to claim 1, wherein the creation unit sets the protruding amount of the borderless printing based on the skew amount, a height of the print medium, and a conveyance amount by which the printing apparatus conveys the print medium to detect the skew amount.

7. The processing apparatus according to claim 1, wherein, in a case where the skew amount is zero, the creation unit sets a minimum reference value as the protruding amount of the borderless printing.

8. The processing apparatus according to claim 6, wherein, in a case where the skew amount is greater than a threshold, the creation unit changes the skew amount to the threshold.

9. A method of controlling a processing apparatus communicating with a printing apparatus, the method comprising:
acquiring a skew amount in feeding of a print medium, detected by the printing apparatus;
creating a print image based on the acquired skew amount, to cause a protruding amount of borderless printing in a case where the skew amount is small to be smaller than the protruding amount of the borderless printing in a case where the skew amount is large; and
outputting the created print image to the printing apparatus.

10. The method according to claim 9, further comprising performing control to display a warning message in a case where the acquired skew amount is greater than a threshold.

11. The method according to claim 9, further comprising performing control to display a screen for selecting automatic setting or designation of the protruding amount of the borderless printing,
wherein, in a case where the automatic setting of the protruding amount of the borderless printing is selected, the creating creates the print image to cause the protruding amount of the borderless printing in the case where the skew amount is small to be smaller than the protruding amount of the borderless printing in the case where the skew amount is large.

12. The method according to claim 9,
wherein, in the borderless printing, the print image having a size larger than a size of the print medium is created, and printing is performed to cause the print image to protrude from the print medium, and
wherein the protruding amount of the borderless printing is an amount of a portion of the print image protruding from the size of the print medium.

13. The method according to claim 9, wherein the creating sets the protruding amount of the borderless printing based on the skew amount, a height of the print medium, and a conveyance amount by which the printing apparatus conveys the print medium to detect the skew amount.

14. The method according to claim 9, wherein, in a case where the skew amount is zero, the creating sets a minimum reference value as the protruding amount of the borderless printing.

15. A non-transitory computer-readable storage medium storing a program for causing a computer to perform a method of controlling a processing apparatus communicating with a printing apparatus, the method comprising:
acquiring a skew amount in feeding of a print medium, detected by the printing apparatus;
creating a print image based on the acquired skew amount, to cause a protruding amount of borderless printing in a case where the skew amount is small to be smaller than the protruding amount of the borderless printing in a case where the skew amount is large; and
outputting the created print image to the printing apparatus.

16. The non-transitory computer-readable storage medium according to claim 15, further comprising performing control to display a warning message in a case where the acquired skew amount is greater than a threshold.

17. The non-transitory computer-readable storage medium according to claim 15, further comprising performing control to display a screen for selecting automatic setting or designation of the protruding amount of the borderless printing,
wherein, in a case where the automatic setting of the protruding amount of the borderless printing is selected, the creating creates the print image to cause the protruding amount of the borderless printing in the case where the skew amount is small to be smaller than the protruding amount of the borderless printing in the case where the skew amount is large.

18. The non-transitory computer-readable storage medium according to claim 15,
wherein, in the borderless printing, the print image having a size larger than a size of the print medium is created, and printing is performed to cause the print image to protrude from the print medium, and
wherein the protruding amount of the borderless printing is an amount of a portion of the print image protruding from the size of the print medium.

19. The non-transitory computer-readable storage medium according to claim 15, wherein the creating sets the protruding amount of the borderless printing based on the skew amount, a height of the print medium, and a conveyance amount by which the printing apparatus conveys the print medium to detect the skew amount.

20. The non-transitory computer-readable storage medium according to claim 15, wherein, in a case where the skew amount is zero, the creating sets a minimum reference value as the protruding amount of the borderless printing.
